(19) United States
(12) Patent Application Publication
(10) Pub. No.: US 2010/0230191 A1
(43) Pub. Date: Sep. 16, 2010

(54) ELECTROCHEMICAL CELL WITH A NON-GRAPHITIZABLE CARBON ELECTRODE AND ENERGY STORAGE ASSEMBLY

(75) Inventors: Peter Birke, Glienicke/Nordbahn (DE); Michael Keller, Baden Baden (DE); Kazuhiro Takahashi, Yamagata-Prefecture (JP); Hideo Yabe, Saitama-Prefecture (JP); Kiyoko Abe, Yamagata-Prefecture (JP); Kazunori Ozawa, Miyagi-Prefecture (JP)

Correspondence Address: RATNERPRESTIA, P.O. BOX 980, VALLEY FORGE, PA, 19482, US

(73) Assignees: TEMIC Automotive Electric Motors GmbH, Berlin (DE); ENAX Inc., Tokyo (JP)

(21) Appl. No.: 12/597,323

(22) PCT Filed: Apr. 23, 2008
(86) PCT No.: PCT/EP08/03270

§ 371 Date: Apr. 1, 2010

(30) Foreign Application Priority Data
Apr. 24, 2007 (DE) 10 2007 019 625.5
May 10, 2007 (DE) 10 2007 022 435.6

(51) Int. Cl. B60K 6/20; H01M 4/58

(52) U.S. Cl. 180/65.21; 429/231.95; 429/231.8; 903/907

(57) ABSTRACT

An electrochemical cell with a cathode electrode and an anode electrode separated by a separator, whereby:
the cathode electrode includes at least a two-phase active material based on a lithium-transition metal oxide, and
the anode electrode includes at least such a material that the anode electrode has an open circuit voltage curve with a total travel of at least 0.7 V and a steep voltage discharge curve without a saddle point.

### CROSS REFERENCE TO RELATED APPLICATIONS

This application is the U.S. national phase application of PCT International Application No. PCT/EP2008/003270, filed Apr. 23, 2008, which claims priority to German Application No. 10 2007 019 625.5, filed on Apr. 24, 2007, and German Application No. 10 2007 022 435.6, filed on May 10, 2007, the content of such applications being incorporated by reference herein.

### FIELD OF THE INVENTION

The present invention relates to an electrochemical cell and an energy storage assembly comprising a plurality of such electrochemical cells and an electric car or a hybrid type electric car using the same. The energy storage assembly (also called battery pack) comprises a plurality of flat electrochemical cells (also called battery cells), each of them comprises a pair of electrodes which electrically connect the electrochemical cells with each other e.g. through outward terminals.

### BACKGROUND OF THE INVENTION

In order to satisfy requirements such as higher input-output power sources for applications, e.g. electric cars, hybrid cars, electric tools, etc. new energy storage assemblies, e.g. lead-acid batteries, lithium-ion batteries, nickel metal hydride batteries, nickel-cadmium batteries and electric double layer capacitors, etc. have been developed.

These new energy storage assemblies power the electric driving motor and the vehicle on-board electrical system. To control the charge-discharge procedures of the energy storage assembly a controller is integrated which manages the charge-discharge procedures, the conversion from braking energy into electric energy (=renewable braking), etc, so that the energy storage assembly can charge during vehicle operation.

The energy storage assembly or each single electrochemical cell should exhibit good characteristics such as a maximum voltage range of 100 V to 450 V with current of 400 A and for extreme condition, e.g. high temperature, with current up to 500 A. Continuous current is in the range of 80 A to 100 A or even also higher depending on the application.

For such extreme conditions the connection of the electrochemical cells of energy storage assembly is extremely stressed.

Accordingly, an object of the invention is to provide an electrochemical cell and an energy storage assembly having a high operation safety and a high reliability, e.g. up to 15 years, under extreme charge/discharge conditions, e.g. in an electric or hybrid type electric vehicle.

### SUMMARY OF THE INVENTION

In order to satisfy this object, an electrochemical cell is provided with a novel combination of electrode materials for the cathode and anode electrodes of a rechargeable battery, especially of a rechargeable lithium ion battery or cell.

In accordance with an aspect of the invention, an electrochemical cell comprises a cathode electrode and an anode electrode separated by a separator, whereby:
the cathode electrode comprises at least a two-phase active material based on a lithium-transition metal oxide, and
the anode electrode comprises at least such a material that the anode electrode has an open circuit voltage curve with a total travel of at least 0.7 V, especially greater 1.3 V, e.g. 1.5 V and a steep voltage discharge curve without a saddle point. Preferably, the material is at least a non-graphitizable carbon material with a higher lattice disorder than graphite. Alternatively, the material is a tungsten dioxide or another suitable junction metallic oxide or a metallic lithium.

The cathode comprises preferably at least an active material, especially a two-phase active material based on lithium-transition metal oxide, e.g. lithium manganese spinel (LiMn₂O₄), Lithium ion phosphate (LiFePO₄), Lithium cobalt phosphate (LiCoPO₄), or another suitable phosphate, such as lithium manganese phosphate (LiMnPO₄) or other materials such as LI(Co_{1/3}Ni_{1/3}Mn_{1/3})O₂, or Li(Ni_{1.5}Mn_{0.5})O₂, LiCoO₂, Li(Ni_{0.8}Co_{0.2})O₂ (partly endowed with Al)

Such a material combination of lithium-transition metal oxide as cathode electrode material and non-graphitizable carbon material with a higher lattice disorder than graphite as anode electrode material allows a high reliability with a high cell safety and high cost efficiency. Furthermore, the cell has a high life expectancy based on a higher charge/discharge capacity without cell mass or cell volume extension. Such an electrochemical cell based on this electrode material combination can be produced simply, efficiently and very fast. The cell, especially the film surface with active electrode material can be efficiently optimized for higher energy density of the cell.

The use of lithium-transition metal oxide as cathode electrode material allows a reaction with lithium in a reversible manner. This dictates an intercalation-type reaction in which the lattice structure essentially does not change when lithium is added. Furthermore, a very rapid reaction with lithium on insertion and removal is given so that a high power density is achieved. Moreover, lithium-transition metal oxide is a common, conventional, low cost and environmental material.

Preferably, the non-graphitizable carbon material for the anode electrode is an amorphous carbon containing hard carbon or soft carbon. Such an electrode material combination of hard carbon or soft carbon for the anode electrode and lithium-transition metal oxide for the cathode electrode exhibits a voltage/state-of-charge curve (V/SoC), especially a voltage discharge curve with a sharp increase so that in case of cell recuperation the risk of lithium plating on the anode electrode is avoided. At the same time the sharp increase of the voltage/state-of-charge curve should not exhibit such sharp increase that the energy density and the available battery capacity depending on the state-of-charge are not strongly reduced.

In a possible embodiment, the hard or soft carbon is a head-decomposed, e.g. by pyrolysis, carbon fiber, e.g. cotton cloth. In one possible way, the hard carbon is prepared by blending lithium compound with carbon precursor to form hard carbon/lithium compound blend used as electrode conductive material of the anode electrode. The soft or hard carbon precursor can comprise at least one of the following components or combinations thereof: petroleum-based pitch, phenol, cellulose, cotton cloth, phenol resin. Such material is very stable by over-discharge and over-charge, i.e. does not change structure or otherwise degrade. Furthermore, the material is a common, conventional, low cost and environmental material. Hard carbon is usually made from a thermosetting resin; soft carbon is usually made from a thermoplastic resin or pitch.

In a further embodiment of the invention, the electrolytic separator comprises at least a polymer or a polymer composite.

In accordance with an aspect of the invention, an energy storage assembly comprises a plurality of flat electrochemical cells each of them comprising a cathode electrode and an anode electrode separated by a separator, whereby:
the cathode electrode comprises at least a two-phase active material based on a metal oxide comprising lithium-transition metal oxide, and
the anode electrode comprises at least such a material that the anode electrode has an open circuit voltage curve with a total travel of at least 0.7 V and a steep voltage discharge curve without a saddle point. Preferably, the anode material is a non-graphitizable carbon material with a higher lattice disorder than graphite.

Depending on the application the electrochemical cells of the energy storage assembly are connected in series, parallelly or in parallel-series.

The invention can be used in electric cars, in hybrid electric vehicles, especially in parallel hybrid electric vehicles, serial hybrid electric vehicles or parallel/serial hybrid electric vehicles. Furthermore, the invention can be used also for storing wind energy or other produced energy, e.g. solar energy. Moreover, the energy storage assembly can also be used as a primary or secondary energy storage device separately or in combination with other energy storage devices in a vehicle power supply system.

The present invention is now further described with particular reference to the following embodiments in the drawing. However, it should be understood that these embodiments are only examples of the many advantageous uses of the innovative teachings herein.

### BRIEF DESCRIPTION OF THE DRAWINGS

FIG. 1 shows a view of an energy storage assembly with a plurality of electrochemical cells which are connected with each other through pairs of outward terminals of each cell, and

FIG. 2 shows a view of one of the electrochemical cells.

### DETAILED DESCRIPTION OF THE DRAWINGS

The present invention relates to an electrochemical cell and an energy storage assembly comprising a plurality of these cells. The invention can be used for different applications, e.g. in a hybrid electric vehicle, whereby the hybrid electric vehicle having a driving motor and an internal combustion engine, wherein the driving motor is driven by power supplied from the energy storage assembly. Alternatively, the energy storage assembly can also be used in an electric car having a driving motor driven by power supplied from the energy storage assembly. Furthermore, the energy storage assembly can be used for storing wind or solar energy for which the assembly is integrated in a wind or solar energy plant.

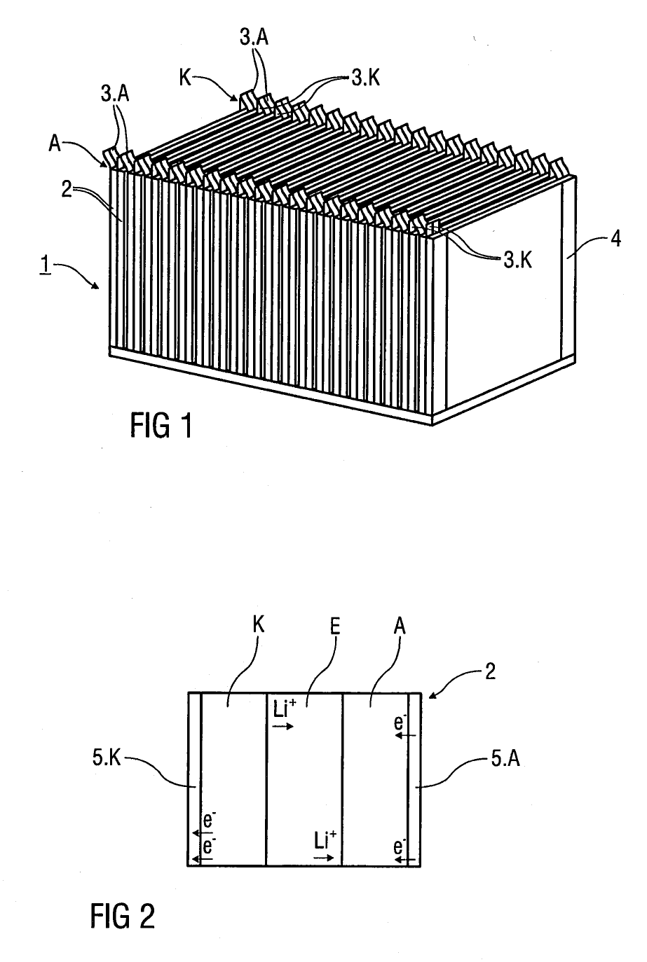

FIG. 1 shows a view of an energy storage assembly 1 (also called battery pack) with a plurality of flat electrochemical cells 2 (also called battery cells or single galvanic cells or prismatic cells).

Each of the electrochemical cells 2 comprises a pair of electrodes A and K, whereby one of the electrodes K is a cathode or positive electrode and the other electrode A is an anode or negative electrode.

Each electrochemical cell 2 is a flat cell, which comprises e.g. as electrodes A and K a plurality of inner electrode films (not shown), whereby different electrode films are separated by a not shown separator film. This separator film rinses with an e.g. non-aqueous electrolyte. Alternatively, instead of films for the electrodes and the separator plates can be used.

To electrically connect the electrochemical cells 2 with each other the electrodes A and K of each cell 2 are connected with outward terminals 3.A and 3.K. Depending on the application the electrochemical cells 2 can be connected through the outward terminals 3.A and 3.K in parallel, in series or in parallel-series.

The shown embodiment according to FIG. 1 presents electrochemical cells 2 which are connected in series.

Furthermore, each cell 2 can be surrounded by a casing 4. The casing 4 can be provided as a film casing or a plate casing which isolates one cell 2 against the adjacent cells.

Preferably, the cells 2 are at least electrically isolated of each other through the casing 4. Additionally, the cells 2 can be thermally isolated of each other depending on the used material. Alternatively, the cells 2 can be electrically connected through the casing surface. Another alternative embodiment can be provided in that a material, e.g. a resin, is filled between the cells 2 for electrical isolation.

The whole energy storage assembly 1 can also be surrounded by a not shown casing, e.g. by a plate casing or a film casing (also called “soft-pack”).

One of the electrochemical cells 2 of the energy storage assembly 1 is shown in FIG. 2 in more detail.

The electrochemical cell 2 is a lithium-ion electrochemical cell.

In a possible embodiment of the invention each electrochemical cell 2 comprises an anode electrode A and a cathode electrode K separated by a separator E. For the electrical connection of the electrochemical cell 2 with other cells the electrodes A, K are electrically connected with conductors 5.A, 5.K. These “inner” conductors 5.A, 5.K are connected with the outward terminals 3.A, 3.K.

The cathode or positive electrode K contains at least an active material, especially a two-phase active material based on lithium-transition metal oxide, e.g. lithium manganese spinel (LiMn₂O₄), Lithium ion phosphate (LiFePO₄), Lithium cobalt phosphate (LiCoPO₄), or another suitable phosphate, such as lithium manganese phosphate (LiMnPO₄) or other materials such as LI(Co_{1/3}Ni_{1/3}Mn_{1/3})O₂, or Li(Ni_{1.5}Mn_{0.5})O₂, LiCoO₂, Li(Ni_{0.8}Co_{0.2})O₂ (partly endowed with Al).

The anode or negative electrode A contains at least such a material that the anode electrode A has an open circuit voltage curve with a total travel of at least 0.7 V and a steep voltage discharge curve without a saddle point. The anode material can be at least a non-graphitizable carbon material with a higher lattice disorder than graphite.

Preferably, the non-graphitizable carbon material is an amorphous carbon containing hard carbon or soft carbon. The hard or soft carbon can be e.g. a head-decomposed, e.g. by pyrolysis, carbon fiber, e.g. cotton cloth.

Such electrode material combination of lithium-transition metal oxide as cathode electrode material and hard or soft carbon as anode electrode material is an optimized combination to achieve an optimized open circuit voltage curve at least without a plateau for high energy storage, long lifetime and minimized cost. Furthermore, as a result of such combination the determination of the battery state is improved.

1-17. (canceled)

18. Electrochemical cell with a cathode electrode and an anode electrode separated by a separator, whereby:
the cathode electrode comprises at least an active material based on a lithium-transition metal oxide and
the anode electrode comprises at least such a material that the anode electrode has an open circuit voltage curve with a total travel of at least 0.7 V and a steep voltage discharge curve without a saddle point.

19. Electrochemical cell according to claim 18, whereby the anode electrode comprises a non-graphitizable carbon material with a higher lattice disorder than graphite.

20. Electrochemical cell according to claim 19, whereby the non-graphitizable carbon material is an amorphous carbon containing hard carbon or soft carbon.

21. Electrochemical cell according to claim 20, whereby the hard carbon is a head-decomposed carbon fiber.

22. Electrochemical cell according to claim 20, whereby the hard carbon is prepared by blending lithium compound with carbon precursor to form hard carbon/lithium compound blend used as electrode conductive material of the anode electrode.

23. Electrochemical cell according to claim 21, whereby the carbon precursor comprises petroleum-based pitch, phenol, cellulose, cotton cloth, phenol resin, or any combination thereof.

24. Electrochemical cell according to claim 18, whereby the cathode electrode comprises at least lithium iron phosphate (LiFePO₄), lithium cobalt phosphate (LiCoPO₄), lithium manganese phosphate or a phosphate.

25. Electrochemical cell according to claim 18, whereby the separator comprises a polymer or a polymer composite.

26. Energy storage assembly with a plurality of flat electrochemical cells each of the cells comprising a cathode electrode and an anode electrode separated by a separator whereby:
the cathode electrode comprises at least a two-phase active material based on a lithium-transition metal oxide, and
the anode electrode comprises at least such a material that the anode electrode has an open circuit voltage curve with a total travel of at least 0.7 V and a steep voltage discharge curve without a saddle point.

27. Energy storage assembly according to claim 26, wherein the anode electrode comprises at least a non-graphitizable carbon material with a higher lattice disorder than graphite.

28. Energy storage assembly according to claim 26, wherein each of the cells comprises a pair of electrodes which electrically connect the electrochemical cells with each other.

29. Energy storage assembly according to claim 26, wherein the electrochemical cells are connected in series.

30. Energy storage assembly according to claim 26, wherein the electrochemical cells are connected in parallel.

31. Energy storage assembly according to claim 26, wherein the electrochemical cells are connected in parallel-series.

32. An electric car having a driving motor driven by power supplied from the energy storage assembly according to claim 26.

33. A hybrid type electric car having a driving motor and an internal combustion engine, wherein the driving motor is driven by power supplied from the energy storage assembly according to claim 26.

34. Usage of the energy storage assembly according to claim 26 as a primary or secondary energy storage device separately or in combination with other energy storage devices in a vehicle power supply system.
